(19) United States
(12) Patent Application Publication
(10) Pub. No.: US 2017/0211831 A1
(43) Pub. Date: Jul. 27, 2017

(54) TRANSITION FOR THERMOSTAT

(71) Applicant: CARRIER CORPORATION, Jupiter, FL (US)

(72) Inventor: Benjamin J. Watson, Collinsville, CT (US)

(21) Appl. No.: 15/415,324

(22) Filed: Jan. 25, 2017

Related U.S. Application Data
(60) Provisional application No. 62/286,761, filed on Jan. 25, 2016.

(51) Int. Cl. F24F 11/00; G05B 19/042

(52) U.S. Cl. CPC F24F 11/006; F24F 11/0012; F24F 11/0086; G05B 19/042; F24F 2011/0013; F24F 2011/0057; F24F 2011/0063; G05B 2219/2614

(57) ABSTRACT

A thermostat associated with a heating, ventilation, and air conditioning system, includes a housing, at least one input, a sensor for measuring an ambient internal temperature, and an internal processor for operating the heating, ventilation, and air conditioning system in response to the at least one input and the measured ambient internal temperature. The thermostat is operable in a heating mode and a cooling mode. A heating set point is associated with the heating mode, and a cooling set point is associated with the cooling mode. The internal processor is programmable to incrementally adjust at least one of the heating set point and the cooling set point in response to a sensed condition.

### CROSS REFERENCE TO RELATED APPLICATIONS

This application claims the benefit of Provisional Application No. 62/286,761, filed Jan. 25, 2016, the contents of which is incorporated by reference in its entirety herein.

### BACKGROUND

This disclosure relates generally to heating and cooling systems of a building and, more particularly, to controlling operation of the heating and cooling systems to limit a rate of temperature change during a transition between a heating operation mode and a cooling operation mode.

Many commercial buildings and residences, particularly in geographic regions experiencing significant changes in temperature through the year, have both heating and cooling systems. The heating system is generally used during the winter and the cooling system is generally used during the summer. Thermostats previously provided for these dual function systems typically include a means for storing a first temperature set point for the heating system, and a means for storing a second set temperature point for the cooling system. At its discretion, a thermostat may actively manage a temperature with a range of acceptable temperatures, or the system may allow the temperature to naturally fluctuate within the range without taking corrective action. If the two set points are adjusted too close to one another, the system may oscillate between heating and cooling modes because the temperatures may overshoot the heating set point during the heating mode and undershoot the cooling set point during the cooling mode. If the set points are set too widely apart, the comfort of the occupants may be diminished.

While the first temperature set point may feel warm during winter months, and the second temperature set point may feel cool during summer months, the first temperature set point may feel cool during summer months and the second temperature set point may feel warm during winter months. The rapid transition that occurs between heating and cooling modes of operation does not account for acclimation of a person to his or her surroundings.

### SUMMARY

According to a first embodiment, a thermostat associated with a heating, ventilation, and air conditioning system, includes a housing, at least one input, a sensor for measuring an ambient internal temperature, and an internal processor for operating the heating, ventilation, and air conditioning system in response to the at least one input and the measured ambient internal temperature. The thermostat is operable in a heating mode and a cooling mode. A heating set point is associated with the heating mode, and a cooling set point is associated with the cooling mode. The internal processor is programmable to incrementally adjust at least one of the heating set point and the cooling set point in response to a sensed condition.

In addition to one or more of the features described above, or as an alternative, in further embodiments the sensed condition includes a change in external temperature indicating a transition between operating in one of the heating mode and the cooling mode to the other of the heating mode and cooling mode.

In addition to one or more of the features described above, or as an alternative, in further embodiments the internal processor incrementally adjusts at least one the heating set point and the cooling set point over a predetermined period of time greater than a day.

In addition to one or more of the features described above, or as an alternative, in further embodiments the predetermined period of time is between about 7 days and 14 days.

In addition to one or more of the features described above, or as an alternative, in further embodiments the sensed condition includes the ambient temperature of a conditioned area.

In addition to one or more of the features described above, or as an alternative, in further embodiments a rate of change of at least one of the heating set point and the cooling set point is between about 1 degree and about 4 degrees per increment.

In addition to one or more of the features described above, or as an alternative, in further embodiments the rate of change of at least one of the heating set point and the cooling set point is generally constant.

In addition to one or more of the features described above, or as an alternative, in further embodiments the rate of change of at least one of the heating set point and the cooling set point varies between increments.

In addition to one or more of the features described above, or as an alternative, in further embodiments the rate of change of at least one of the heating set point and the cooling set point is a set by a user.

In addition to one or more of the features described above, or as an alternative, in further embodiments the rate of change at least one of the heating set point and the cooling set point is calculated based one or more parameters.

According to another embodiment, a method of adjusting a set point temperature of a thermostat includes sensing a condition and incrementally adjusting at least one of the heating set point and the cooling set point of the thermostat in response to the sensed condition.

In addition to one or more of the features described above, or as an alternative, in further embodiments the sensed condition indicates a transition of the thermostat between a heating mode and a cooling mode, the heating set point being associated with the heating mode and the cooling set point being associated with the cooling mode.

In addition to one or more of the features described above, or as an alternative, in further embodiments the transition between the heating mode and the cooling mode is initiated when a sensed daily temperature change exceeds a threshold for a predefined number of days.

In addition to one or more of the features described above, or as an alternative, in further embodiments identifying a difference between a cooling set point associated with the cooling mode and a heating set point associated with the heating mode.

In addition to one or more of the features described above, or as an alternative, in further embodiments the sensed condition occurs via an input provided by a user.

In addition to one or more of the features described above, or as an alternative, in further embodiments sensing a condition includes determining a previous temperature of an area being conditioned by the thermostat.

In addition to one or more of the features described above, or as an alternative, in further embodiments wherein a rate of change of at least one of the heating set point and the cooling set point is between about 1 degree and about 4 degrees per increment.

In addition to one or more of the features described above, or as an alternative, in further embodiments wherein the rate of change of at least one of the heating set point and the cooling set point is generally constant.

In addition to one or more of the features described above, or as an alternative, in further embodiments the rate of change of at least one of the heating set point and the cooling set point varies between increments.

In addition to one or more of the features described above, or as an alternative, in further embodiments incrementally adjusting at least one of the heating set point and the cooling set point occurs over a predetermined period of time greater than a day.

### BRIEF DESCRIPTION OF THE DRAWINGS

The subject matter, which is regarded as the present disclosure, is particularly pointed out and distinctly claimed in the claims at the conclusion of the specification. The foregoing and other features, and advantages of the present disclosure are apparent from the following detailed description taken in conjunction with the accompanying drawings in which:

FIG. 1 is a front view of an example of a thermostat

FIG. 2 is a graph comparing operational mode and temperature set-point of a conventional thermostat;

FIG. 3 is a graph comparing an operational mode and a temperature set-point of a thermostat according to an embodiment;

FIG. 4 is a graph illustrating an incrementally adjusted heating set point and cooling set point during a fast change in external temperature as controlled by an algorithm according to an embodiment;

FIG. 5 is a graph illustrating an incrementally adjusted heating set point and cooling set point during a fast change in external temperature as controlled by an algorithm according to an embodiment; and

FIG. 6 is a graph illustrating an incrementally adjusted heating set point and cooling set point during a gradual change in external temperature as controlled by an algorithm according to an embodiment.

The detailed description explains embodiments of the present disclosure, together with advantages and features, by way of example with reference to the drawings.

### DETAILED DESCRIPTION

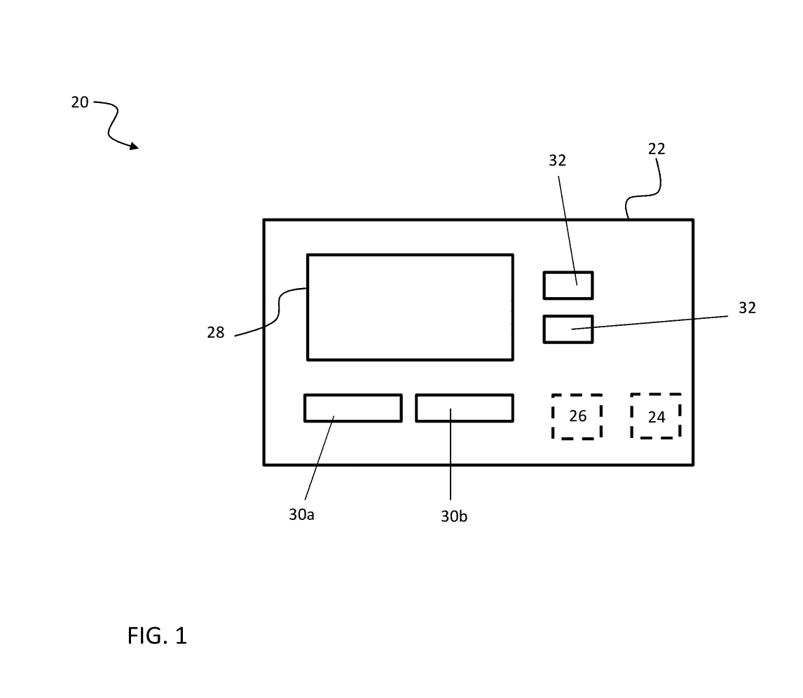

Referring now to FIG. 1, an example of a thermostat 20 associated with a heating, ventilation, and air conditioning (HVAC) system is illustrated. The thermostat 20 includes a housing 22 within which an internal temperature sensor 24 monitored by an internal processor 26 is positioned. The thermostat 20 additionally includes a user display 28 which is used to communicate programmatic, system, and ambient information regarding the operation of the HVAC system. The user display 28 may take any number of forms known in the art, such as an LCD screen for example. The thermostat 20 additionally includes a plurality of operational inputs 30, such as buttons or keys for example. In the illustrated, non-limiting embodiment, the thermostat 20 includes a first input 30a operable to select one of a plurality of operational statuses, for example, heat, cool, and off, and a second input operable 30b to select between manual adjustment and programmable adjustment of the thermostat settings. The functionality instituted upon operation of these inputs 30 may be illustrated on the display 28. The functional indicators associated with the inputs 30 may vary based on the program state and mode in which the thermostat is operating.

In addition to these operational inputs, the thermostat 20 may include one or more adjustment inputs 32 configured to adjust a currently selected parameter incrementally, such as for increasing or decreasing a desired temperature at which the thermostat 20 will maintain the ambient environment. Although the thermostat 20 illustrated and described herein includes four inputs, a thermostat 20 having any number and any type of inputs, such as an alphanumeric keypad, a rotatable knob, a slidable bar, a toggle switch, or a touch screen for example, are within the scope of the disclosure.

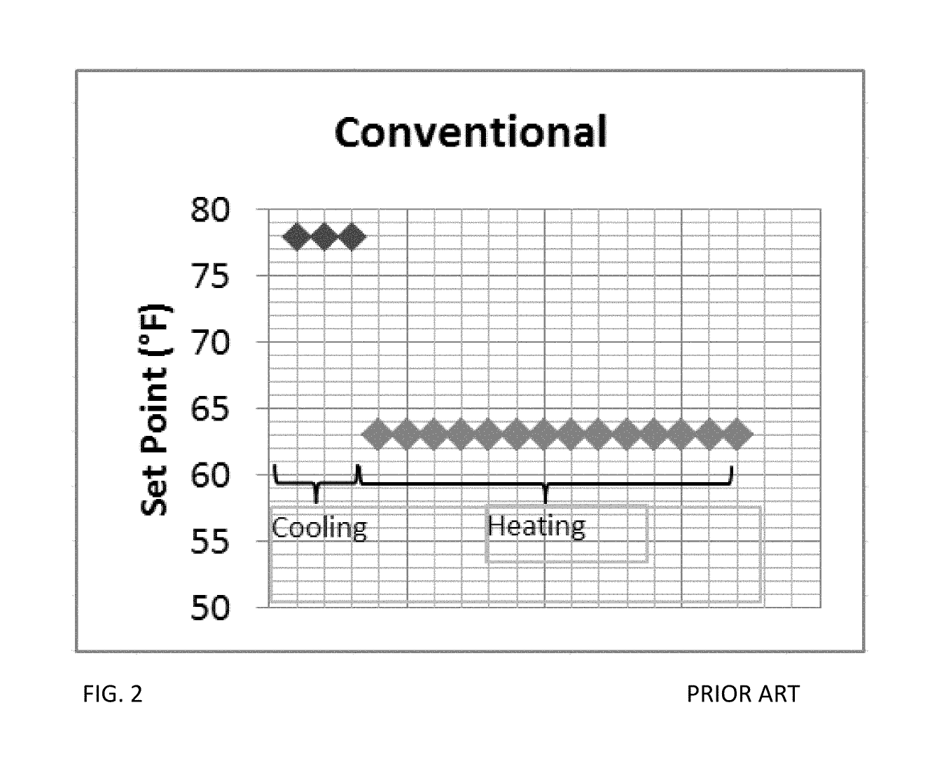

Thermostats 20 typically operate in one of a heating mode or a cooling mode. In geographic regions having significant temperature changes between summer and winter, thermostats 20 are generally operated consistently in the heating mode during the cooler winter months and in the cooling mode during the warmer summer months. When a conventional thermostat is operated in either a heating mode or a cooling mode, the thermostat is configured to initiate heating or cooling if the sensed temperature is beyond a set point associated with the mode of operation. For example, as shown in FIG. 2, in the heating mode, heating is initiated if a sensed temperature is below a heating set point, such as 63° F. for example. Similarly, in the cooling mode, cooling is initiated if the sensed ambient temperature is above a cooling set point, such as 78° F. for example. Typically, a user will define the heating set point and cooling set point based upon the user's comfort preferences. Sometimes, these set points may be the same. However, often these set points differ by a number of degrees. In addition, it should be understood that the operational mode of the thermostat 20 or the set point may be adjusted, manually or automatically throughout the day to reduce energy. In one embodiment, the thermostat is configured to maintain a desired temperature during only peak hours, such as between 8 am and 6 pm, when the building is occupied. During off-peak hours, the set-point may be adjusted to closer to the external temperature to reduce the work of the HVAC system.

Thermostats, like thermostat 20, which are capable of switching between heating and cooling modes automatically, may be configured to do so in response to either a programmed date or when the sensed temperature is continuously below the heating set point or above the cooling set point, to indicate a change in season. With reference now to FIG. 2, when a conventional thermostat switches between a cooling and heating mode, the set point for operation of the HVAC system automatically transitions from the set point of cooling mode to the set point of the heating mode such as via a step function. As shown, the set point of operation will shift from 78° F. to 63° F. such that the thermostat 20 will only operate the system once the sensed temperature is below the heating set point, resulting in a substantial temperature change. For example, if winter is ending and summer is beginning, the system will switch from heating when the interior temperature falls below 63° F. to cooling when the interior temperature exceeds 78° F. If this change is immediate, the user may be uncomfortable.

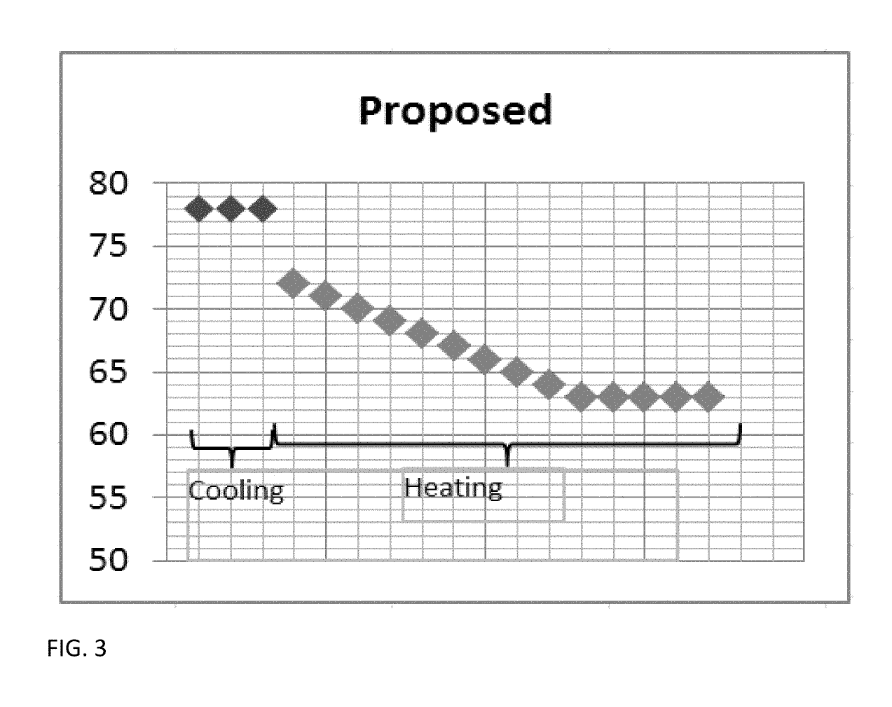

To avoid such drastic changes in the conditioned temperature of a room when a quick change in external temperature occurs, the thermostat 20 may be configured to gradually adjust one or more heating and cooling set points. For example, the processor 26 of the thermostat 20 may include an algorithm for regulating the rate at which the set-point changes. With reference now to FIG. 3, in the illustrated, non-limiting embodiment, the algorithm may be used to control the operational set-point when transitioning between the cooling and heating operational modes to prevent excessive changes in temperature within a defined period of time. Initiation of the transition between the operational modes of the system may occur in response to an input by a user, or alternatively, may occur automatically in response to one or more sensed conditions. For example, the thermostat 20 may be conditioned to switch been a heating mode and a cooling mode if the ambient temperature exceeds the heating set point by a threshold, such as five degrees for example, for a predetermined period of consecutive days, such as five days in a row for example. In one embodiment, the threshold may be greater or less than five degrees, and may or may not be adjustable by the user. In one embodiment, the determined period of consecutive days may be greater or less than five degrees, and may or may not be adjustable by the user. In one embodiment, the threshold and period of time may be selected to detect a seasonal change.

The transition of the set-point may occur over any period of time greater than a day, and will generally be less than a month, such as between about 7 and 14 days for example. The incremental change in the set-point determined by the algorithm may be a preset value, such that the change in the set point temperature is generally linear as shown in the exemplary embodiment of FIG. 3. Alternatively, each incremental change in set point temperature may be calculated based on one or more parameters. As a result, the change in set point between increments may vary. At least one of the rate of change of the set point and the length of time over which the set point transitions between the cooling mode set point and the heating mode set point or vice versa, may depend on the difference between the cooling mode set point and the heating mode set point and the maximum allowable change in temperature to which a body can adapt in a predefined period of time, such as a day for example. For example, the change in the set point may be between about 1 degree and 4 degrees per increment such that the change is small enough to be substantially imperceptible to a person. In one embodiment, a user may define a maximum allowable change in temperature per increment with which they are comfortable.

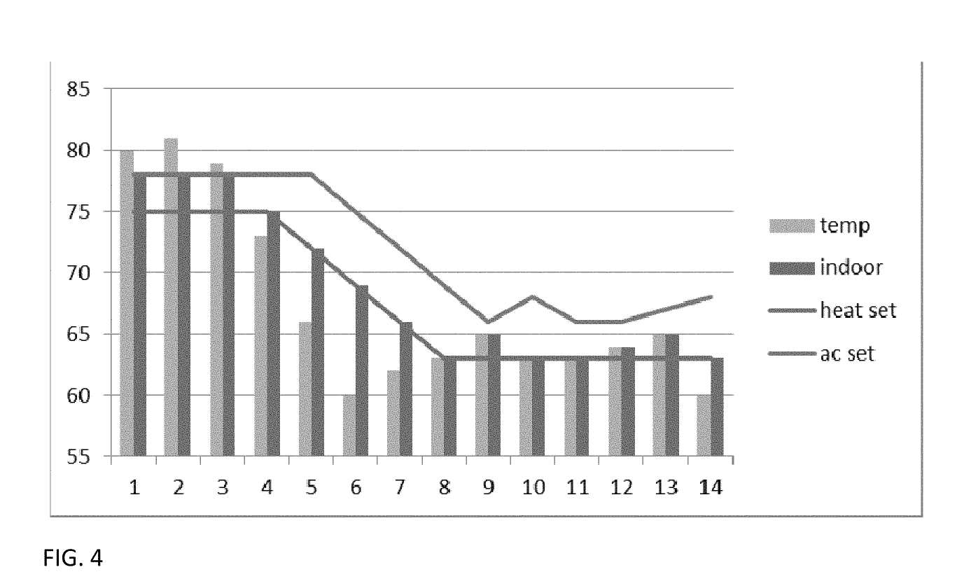

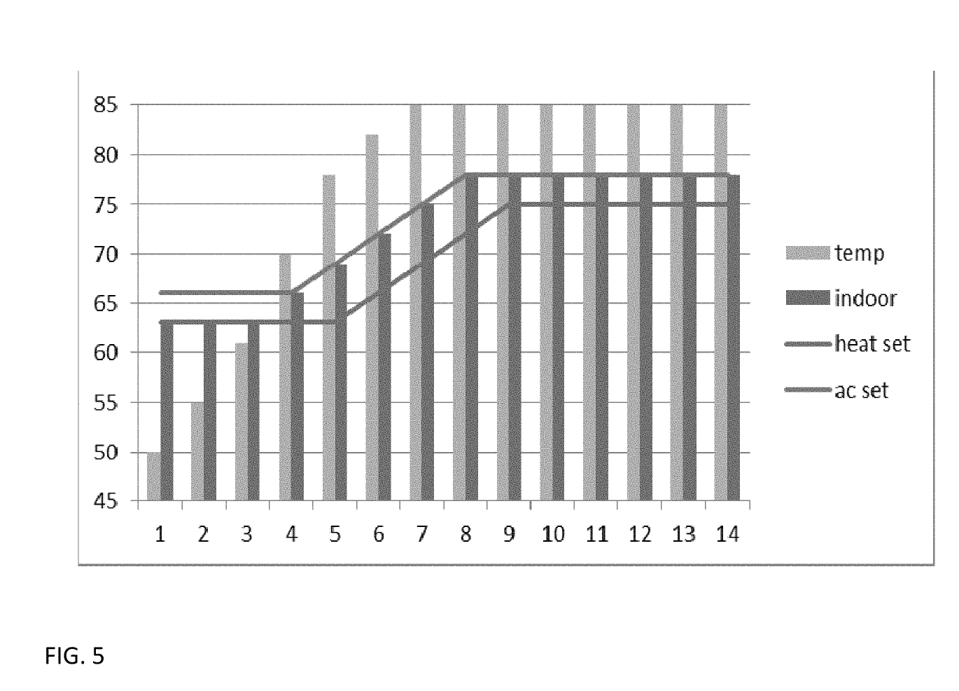

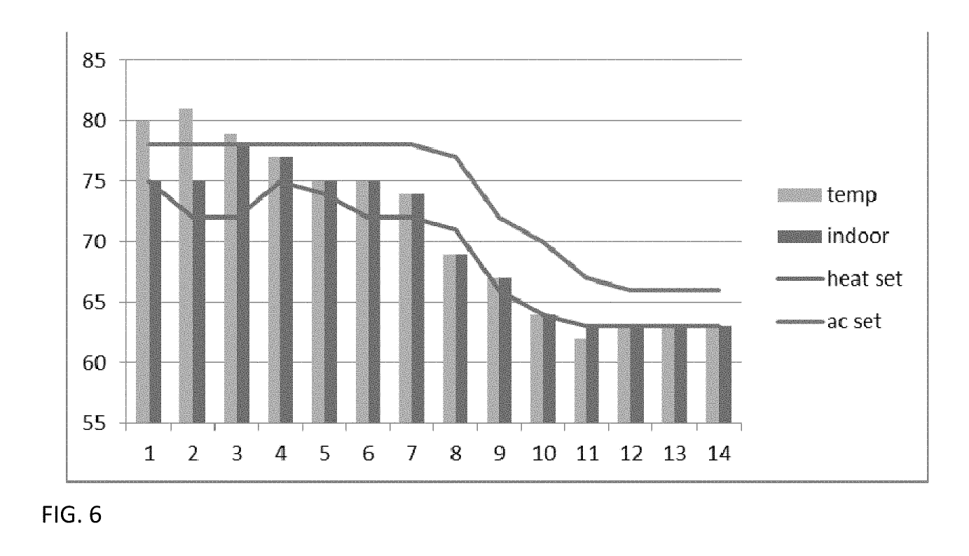

In another embodiment, as illustrated in FIGS. 4 and 5, the algorithm of the thermostat 20 may be configured to automatically adjust one or more of the heating and cooling set points in response to a previously sensed temperature, such as the ambient temperature within the conditioned area during the previous day, or over an average period of time. For example, the algorithm may automatically define the heating set point as the previously sensed temperature plus a first value and define the cooling set point as the previously sensed temperature minus a second value. The first and second value may be the same or may be different. The first and second value may be a pre-defined number, such as entered by a user for example, or may be calculated in response to one or more sensed parameters. In the illustrated non-limiting embodiment of FIGS. 4 and 5, the algorithm is configured to calculate the heating set point as the ambient conditioned temperature of the previous day minus three degrees and to calculate the cooling set point as the ambient conditioned temperature of the previous day plus three degrees. In one embodiment, the first and second value may be greater than or less than three degrees. FIGS. 4 and 5 illustrate how the set point will adjust in instances when external temperature drops drastically or increase drastically, respectively. FIG. 6 illustrates how the set point will adjust in instances where the external temperature makes a more gradual transition. It should be noted, however, in any embodiment, a user may be able to manually override the change in set-point determined by the thermostat 20.

By incrementally adjusting the set point temperature daily during the transition between a heating mode and a cooling mode of operation, a person may better adapt to the change between the heating and cooling set points over time. As a result of this more gradual transition, the perceived temperature change will be reduced, which may improve a person's mental and physical health.

While the present disclosure has been particularly shown and described with reference to the exemplary embodiments as illustrated in the drawing, it will be recognized by those skilled in the art that various modifications may be made without departing from the spirit and scope of the present disclosure. Therefore, it is intended that the present disclosure not be limited to the particular embodiment(s) disclosed as, but that the disclosure will include all embodiments falling within the scope of the appended claims.

What is claimed is:

1. A thermostat associated with a heating, ventilation, and air conditioning system, comprising:
a housing;
at least one input;
a sensor for measuring an ambient internal temperature; and
an internal processor for operating the heating, ventilation, and air conditioning system in response to the at least one input and the measured ambient internal temperature;
wherein the thermostat is operable in a heating mode and a cooling mode, a heating set point being associated with the heating mode, and a cooling set point being associated with the cooling mode, wherein the internal processor is programmable to incrementally adjust at least one of the heating set point and the cooling set point in response to a sensed condition.

2. The thermostat according to claim 1, wherein the sensed condition includes a change in external temperature indicating a transition between operating in one of the heating mode and the cooling mode to the other of the heating mode and cooling mode.

3. The thermostat according to claim 2, where internal processor incrementally adjusts at least one the heating set point and the cooling set point over a predetermined period of time greater than a day.

4. The thermostat according to claim 3, wherein the predetermined period of time is between about 7 days and 14 days.

5. The thermostat according to claim 1, wherein the sensed condition includes the ambient temperature of a conditioned area.

6. The thermostat according to claim 1, wherein a rate of change of at least one of the heating set point and the cooling set point is between about 1 degree and about 4 degrees per increment.

7. The thermostat according to claim 6, wherein the rate of change of at least one of the heating set point and the cooling set point is generally constant.

8. The thermostat according to claim 6, wherein the rate of change of at least one of the heating set point and the cooling set point varies between increments.

9. The thermostat according to claim 6, wherein the rate of change of at least one of the heating set point and the cooling set point is a set by a user.

10. The thermostat according to claim 6, wherein the rate of change at least one of the heating set point and the cooling set point is calculated based one or more parameters.

11. A method of adjusting a set point temperature of a thermostat, comprising:
sensing a condition; and
incrementally adjusting at least one of the heating set point and the cooling set point of the thermostat in response to the sensed condition.

12. The method according to claim 11, wherein the sensed condition indicates a transition of the thermostat between a heating mode and a cooling mode, the heating set point being associated with the heating mode and the cooling set point being associated with the cooling mode.

13. The method according to claim 12, wherein the transition between the heating mode and the cooling mode is initiated when a sensed daily temperature change exceeds a threshold for a predefined number of days.

14. The method according to claim 12, further comprising identifying a difference between a cooling set point associated with the cooling mode and a heating set point associated with the heating mode.

15. The method according to claim 11, wherein the sensed condition occurs via an input provided by a user.

16. The thermostat according to claim 11, wherein the sensed condition includes a previous temperature of an area being conditioned by the thermostat.

17. The method according to claim 11, wherein a rate of change of at least one of the heating set point and the cooling set point is between about 1 degree and about 4 degrees per increment.

18. The method according to claim 17, wherein the rate of change of at least one of the heating set point and the cooling set point is generally constant.

19. The method according to claim 17, wherein the rate of change of at least one of the heating set point and the cooling set point varies between increments.

20. The method according to claim 11, wherein incrementally adjusting at least one of the heating set point and the cooling set point occurs over a predetermined period of time greater than a day.
